(19) United States
(12) Patent Application Publication
(10) Pub. No.: US 2014/0374154 A1
(43) Pub. Date: Dec. 25, 2014

(54) METHOD FOR PRODUCING AN ELECTRICAL RADIOFREQUENCY CONNECTION BETWEEN TWO PLATE-SHAPED CONDUCTOR TRACK SECTIONS AND AN ASSOCIATED ELECTRICAL RADIOFREQUENCY CONNECTION

(71) Applicant: KATHREIN-WERKE KG, Rosenheim (DE)

(72) Inventors: Christian Frohler, Halfing (DE); Mario Günther, Kolbermoor (DE)

(21) Appl. No.: 14/368,236

(22) PCT Filed: Dec. 6, 2012
(86) PCT No.: PCT/EP2012/005036

§ 371 Date: Jun. 23, 2014

(30) Foreign Application Priority Data
Dec. 22, 2011 (DE) 10 2011 122 037.6

(51) Int. Cl. H01R 43/048; H01R 4/18

(52) U.S. Cl. CPC H01R 43/048; H01R 4/182
USPC 174/84 C; 29/882

(57) ABSTRACT

An electrical radiofrequency galvanic or capacitive electrical connection between two plate sections uses at least two conductor track sections to be connected electrically. The conductor track sections are arranged at a distance from one another, lying parallel to one another, at least in a plate region of the conductor track sections which remains undeformed during the production process. The at least two conductor track sections are connected to one another in a connection region using a clinching tool so as to produce a clinched joint.

In electrical engineering in general, and in mobile communications in particular, especially in the construction of antenna systems for base stations in mobile communications, electrically conductive tracks and portions often have to be electrically interconnected.

It is thus known for example from DE 10 2005 047 975 A1 and U.S. Pat. No. 7,358,924 B2 that a plurality of strip-shaped conductor tracks made from sheet metal are used upstream from a reflector plate of a mobile communication antenna, and need to be electrically interconnected or coupled together. According to this prior publication, it has been proposed for various reasons to couple two conductor tracks consisting of a metal strip capacitively.

In principle, aside from a capacitive coupling, a plurality of known electrical connection types could be used, for example in that two electrically conductive metal strips are welded or soldered together. In principle, it would also be possible for two metal plates or strip-shaped metal conductor plates, which are to be electrically interconnected, to be screwed or riveted together. A contact face can be formed by deformation.

Generally speaking, the object and aim in applications of this type is always to ensure a permanent electrical and mechanical connection, which meets the highest requirements in terms of quality, makes high reproducibility and process monitoring possible, and especially also damage-free testing. The connection type used should have a long service life, and if possible not be subject to corrosion, or only to very slight corrosion and deterioration.

Aside from the cost-effectiveness and process reliability, high manufacturing compatibility should also be provided; among other things, the connection type should have low tolerances and low warping, and if possible should also make subsequent manufacturing steps possible.

However, in electrical engineering in general and in high-frequency technology in particular, and thus also especially in the field of mobile communications, there is also the problem that the respectively used connection type additionally has to ensure that no intermodulations occur, including as a result of tolerance or corrosion problems. Further, what is known as the standing wave ratio, specifically what is known as the voltage standing wave ratio (VSWR), should be as low as possible, in other words have a minimal reflection, or ideally none, on the line in question, in other words it should approach 0 if a line is terminated ideally.

It should also be noted that in mobile communications there is a relatively high transmission level and by contrast a very low reception level at the base stations. The very low reception level is due to the relatively low transmission power of the mobile device, which is further attenuated by the distance. Thus, the receiver of the base station only receives a very low input power. For the receiver not to be interfered with in the case of two transmission signals (having a high signal level), the (passive) intermodulation products generated in the shared antenna path must be for example 140 dB lower than the transmission level. This high requirement is sufficient for effects such as microscopic defective contact points or material impurities to become noticeable.

It is against this background that the issue of a suitable high-frequency connection type arises.

A wide range of electrical connection types are known. For example, DE 102 05 521 A1 discloses that for example two metal structures can be electrically contacted with one another in the region of lobe-shaped projections, at least one of the two metal structures having a protruding contact region facing the respective other metal structure. An electrically insulating layer should be arranged between the metal structures. The aforementioned electrical contacting should be produced using suitable measures such as welding, soldering, pressure-crimping, rivets, bonding, sintering, reaction welding or reaction joining.

In addition, an example of fixing an electrical component to a lamp is known for example from EP 1 045 201 A1. For this purpose, the electrical component comprises a metal base body, as does the lamp. The two metal base bodies are brought into a mutually parallel position, so as subsequently to connect the electrical component, at one or more suitable points in the sheet metal housing thereof, preferably in the region of the support plate, to the metal mounting sheet of the lamp in an electrically conductive manner, by welding, cutting, pressure joining or in some other way.

A similar method is also known for example from DE 10 2007 032 142 A1. An electronic module and a method for the manufacture thereof are disclosed. For this purpose, the electronic module comprises a first and a second substrate, which is formed as a die-cast housing or transfer-moulded housing. The substrate comprises further terminals which are formed as pressed screens. The terminals of the second substrate are also formed as pressed screens, the two pressed screens thus being interconnected directly at at least one point. The electrically conductive metal sheets, which are positioned against one another over the whole area of this region, are electrically interconnected at the points to be connected, for example by a welded, tox and/or clamping connection.

For a further example of a similar connection type, reference is made to prior publication DE 299 12 797 U1. This discloses an electronic assembly unit comprising an electrically conductive busbar, to which at least one contact link of an electrical apparatus is to be connected. The connection should be produced by mechanical pressure joining by means of a suitable punch-die combination. In this way, the two plates or conductor tracks which are positioned against one another can be interconnected via the joining connection so as to be positioned against one another over the whole area.

These connection types are usually electrical contacts to the earth or to another potential.

It is also known in principle from DE 199 29 377 A1 how two metal sheets having an intermediate plastics material plate can be interconnected using a clinching method for producing a purely mechanical connection. However, the method disclosed therein merely serves to produce a mechanical and not an electrical connection, in particular partly because this prior publication assumes that the plastics material plate located between the two metal sheets may or may not tear during the production of a clinching connection, but this is irrelevant for producing a mechanical connection.

The object of the present invention is to provide an improved electrical high-frequency connection between at least two or more metal plate-shaped conductor track portions, which can be produced as simply as possible, it being possible and intended to use said connection permanently, without difficulties, in a mechanical and especially an electrical regard, so as especially to keep the risk of modulations occurring or of a poor VSWR property as low as possible in this case.

The object is achieved for the method by the features of claim 1 and for a correspondingly produced electrical connection by the features of claim 11 or 19. Advantageous embodiments of the invention are specified in the dependent claims.

Within the invention, it is possible mechanically to interconnect two electrically conductive plates, for example two metal or alloy strips, durably and rigidly, this connection durably withstanding extremely high force loads. It is surprising that for the type of connection used it is now possible, in the field of high-frequency technology in general and mobile communications in particular, additionally to configure the connection as a good electrical connection between at least two electrically conductive plate-shaped bodies, without intermodulations occurring and without worsening the VSWR property by comparison with other connection types. By contrast, it may even be seen that the at least two electrically conductive plates in the context of the invention can be mechanically connected more durably and rigidly, with improved intermodulation and VSWR properties, than for conventional connection types.

In the method according to the invention, the at least two plates are interconnected by the technique of clinching (toxing), which is known per se and in which for example two metal sheets are interconnected using a longitudinally displaceable punch and a die, arranged in a fixed manner with respect to the punch housing and having a corresponding deep-draw opening. By introducing the punch into the die parts, the corresponding plate-shaped portions of the plates to be connected are deformed together in such a way that the upper plate on the punch side engages in portions located below it of the plate located below it, specifically in undercutting portions, in such a way that an optimal mechanically rigid connection is produced.

However, this connection type would not be suitable in the field of high-frequency technology, since the electrically conductive plates are electrically contacted via the fixing point and thus would have contacts which are not definitively reproducible and which are additionally subject to fluctuations, meaning that considerable intermodulation problems would occur. As a result, the standing wave ratio would also become drastically worse.

The invention therefore advantageously provides that, prior to or simultaneously with the clinching, the upper metal sheet, in other words the upper plate, undergoes embossment, in which the upper plate initially experiences a pot-shaped or pan-shaped bulging with respect to the second plate located below.

Subsequently, the clinching can preferably be carried out within the invention similarly to in the prior art. As in the prior art, the material portions thus deformed of the two plates are deformed by the high pressure and the resulting flowability of the material, specifically in an undercutting manner, resulting in the mechanical connection being produced in a known manner.

The connection type according to the invention is distinguished primarily in that the connection of two electrically conductive plate portions is not only extremely rigid and mechanically stable, but above all highly suitable for galvanic connection, as has been shown, particularly since no undesirable intermodulations occur.

In particular if the aforementioned advance embossment is carried out with a pot-shaped, shell-shaped, plate-shaped or pan-shaped depression in the first or second plate, this results in a circumferential flare or annular flare, which ensures that one plate is held at a distance from the other plate by the flared connection region, so as subsequently to produce the actual joining connection in a following further or separate second method step.

In other words, the mechanical and thus the electrical connection are provided substantially only in the region of the metal plates or metal strips etc. to be connected, which region is deformed, thus including the region which has for example received a peripheral plate-shaped flare during the shaping.

By the described method, it is preferably possible to provide a galvanic connection between the two plates and the plate portions. Within the invention, however, a galvanic connection may also equally be produced between two plate portions in that at least in the region outside the joining connection, in other words in the region where the plates generally remain undeformed, a film or film layer which keeps the two plates at a distance is arranged between them, in particular an insulating film layer. This preferably comprises a clearance (hole) in the region of the joining connection, so as to connect the two plates galvanically here as desired. In particular in this case, it is possible to dispense with the aforementioned embossment with the formation of a peripheral flare, via which the plates can be positioned at a distance from one another (so as subsequently to carry out the joining connection in a further or subsequent step).

Equally, however, a capacitive electrical connection can be produced in that the two electric plates to be connected are laid on another with an insulating film or film layer interposed and subsequently the joining connection is produced as described in a connection region. The insulating film layer keeps the two plates portions at a distance from one another even in the connection region of the joining connection, so as to make the capacitive coupling possible here in particular. This has major advantages in high-frequency technology in particular.

Although reference is sometimes made to a film, insulating film or film layer, both above and in the following, this need not necessarily be a film, or even a separate film layer to be positioned between the plates. It is equally possible to use a plate, in particular an insulating plate, which is also deformed. The insulating layer may not only be provided as a separate insulating plate or film layer, but for example also in the form of a coating, lacquering, powder coating, calender coating etc., which is formed on at least one surface of the two plates to be connected. In other words, as a result the two plates to be connected are mutually galvanically separated by the insulating layer formed on at least one surface of the at least two plates to be connected, so as to provide the capacitive coupling by the clinching method.

A method for producing an electrical installation device is also known in principle from DE 44 31 274 C2. This prior publication discloses the installation of a contact bridge, in which the associated bridge element and contact elements are initially prefabricated as separate parts. These separate parts are then each to be used separately in a corresponding recess of the housing part of the device, in such a way that the connection regions thereof subsequently lie loosely against one another. When inserted and fixed in a recess in this manner, the parts are subsequently interconnected in a direct positive fit in the respective connection regions by clinching. For this purpose, a die and a round punch are moved towards one another on the joining axis, causing the metal sheet connection regions to be pressed into an opening in the die in such a way that a direct positive connection occurs as a result of material flowing around. This is thus a special method for producing an electrical installation device, whereas in the present invention an electro-galvanic or electro-capacitive connection is generally to be produced between two plate-shaped parts which may be for use in particular in high-frequency technology, in particular specifically in mobile communications. All high frequencies suitable for mobile communications are possible within the invention, but the invention is not limited to these.

As is known, in clinching the die used may be equipped with a rim or channel at the transition from the die base to the die wall, making it possible for more material of the lower plate to flow into this region, ensuring in a known manner that the material of the upper plate engages behind corresponding undercuts which occur in the region of the lower plate and thus contributes to an improved connection.

Preferably, within the invention, an adapted scraper or what is known as a hold-down device is used, and ensures that, when the punch is withdrawn, the plates connected by the joining process are held a distance from one another adjacent to the respective connection point in the connection region thereof, without being subjected to undesired deformations.

However, the nature of the connection means that it would also theoretically be possible to connect more than two plates of this type, as is known in principle for example from WO 01/00347 A2, where for example three plates are interconnected by clinching, specifically two metal plates arranged mutually parallel and a plastics material plate arranged between them.

The inventive solution may also advantageously be used when a film is sandwiched interposed between the plate-shaped elements to be connected. A capacitive coupling is thus produced at the preferred connection point. The electrically non-conductive film which otherwise extends between the two plate-shaped elements can thus be made thicker, in other words becoming thinner in the region of the joining connection as a result of the material stretching, making it possible to set a desired capacitance.

However, it is also likewise possible to provide a film between the two plate-shaped elements to be connected, the film comprising a hole-shaped clearance in the region of the joining connection. Within the invention, the plates, which preferably extend mutually parallel, can thus be connected correspondingly by way of the joining connection, it no longer being absolutely necessary in this aforementioned case initially to form a pot-shaped depression in advance in at least one of the two plates to be connected, so as to keep the plates in mutual contact here prior to further machining.

The invention is described in greater detail in the following by way of drawings of individual examples of the invention, in which, in detail:

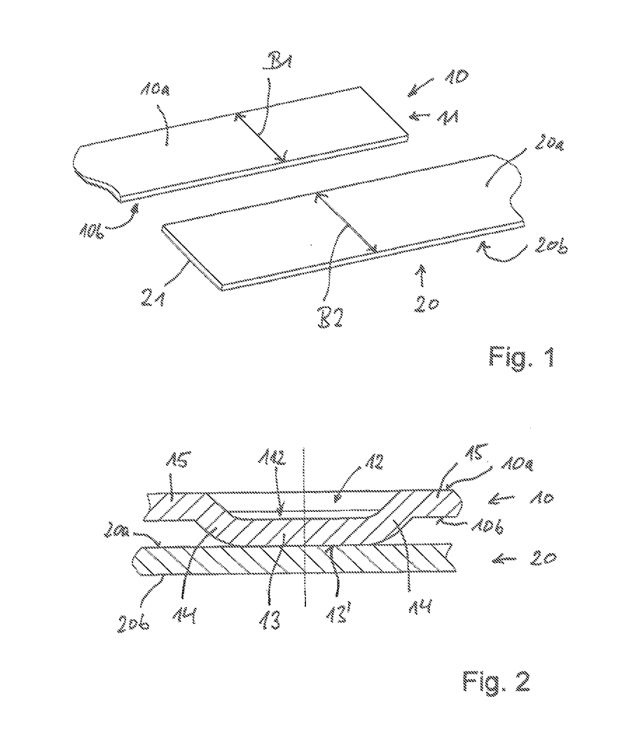

FIG. 1 is a schematic three-dimensional detail of two plates to be connected;

FIG. 2 is a schematic cross-sectional drawing through two plates to be connected, which are arranged in a mutually parallel position, the upper plate already having received a bulge, at the connection point (connection region) to be produced, towards the second plate located below in a first method step;

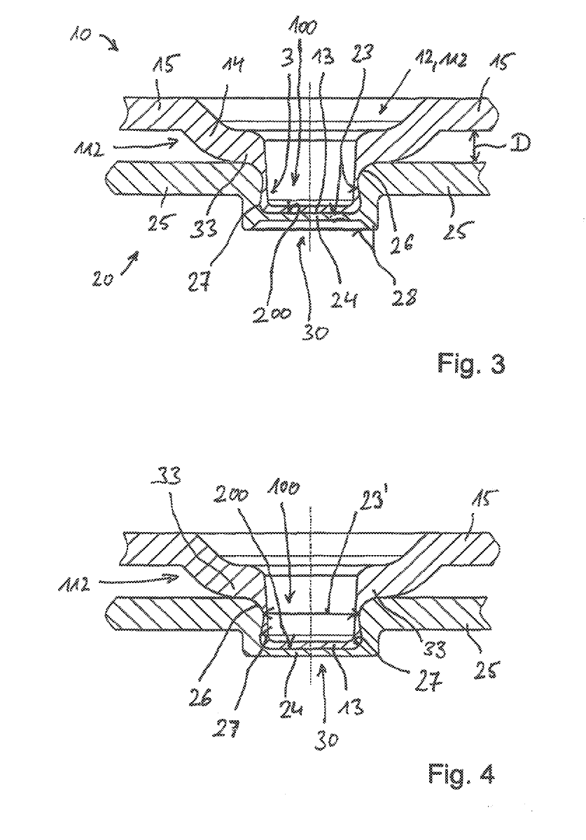

FIG. 3 is a corresponding cross-sectional drawing of the plates shown not yet connected in FIGS. 1 and 2, which are connected in the connection region thereof by clinching in FIG. 3;

FIG. 4 is a cross-section of an embodiment slightly modified from FIG. 3;

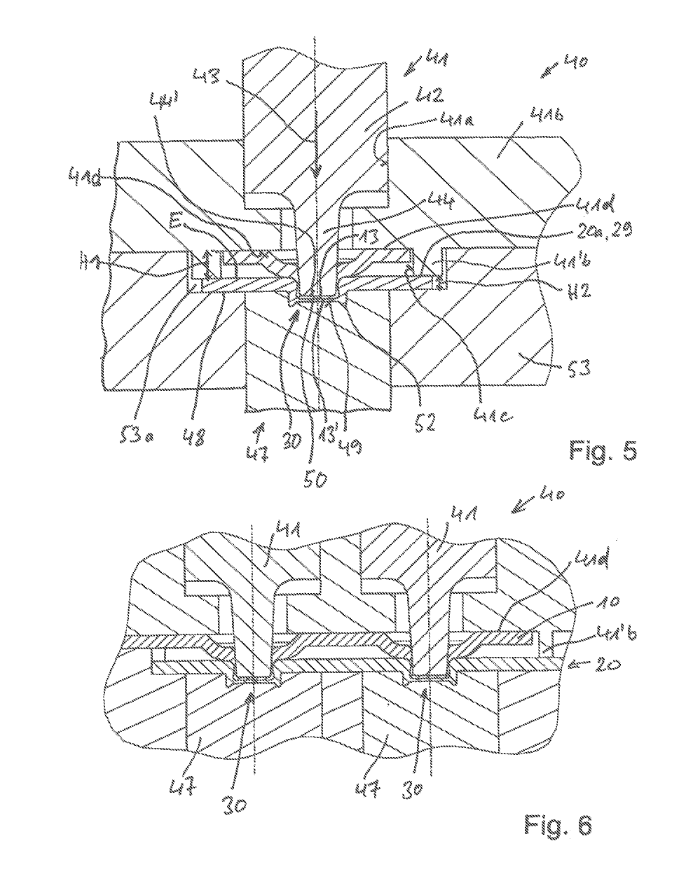

FIG. 5 is a schematic cross-sectional drawing through the two electrically conductive plates to be connected, in a corresponding tool having a press punch above and a die arranged below;

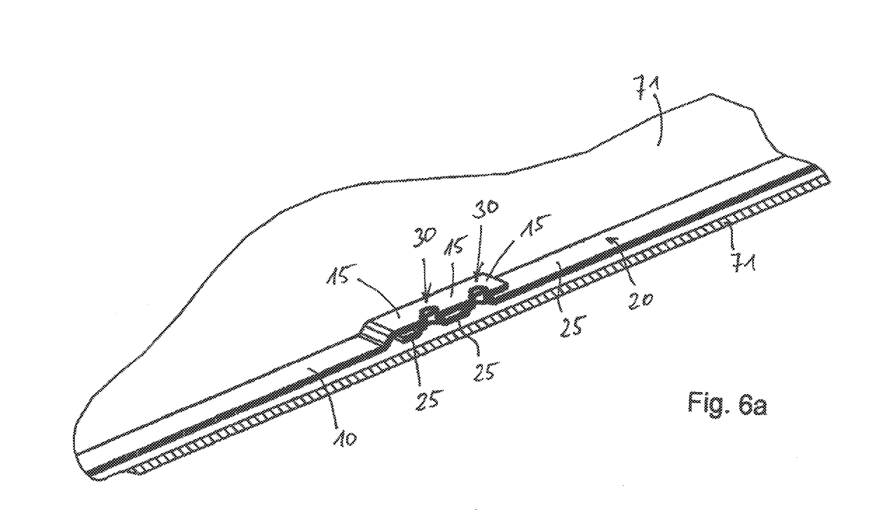

FIG. 6 is an embodiment modified from FIG. 5, illustrating how two clinching connections could be produced mutually adjacently using one clinching tool simultaneously;

FIG. 6a is a three-dimensional, partly sectional drawing of two connected metal strips, two adjacent connection regions being mechanically and electro-galvanically connected;

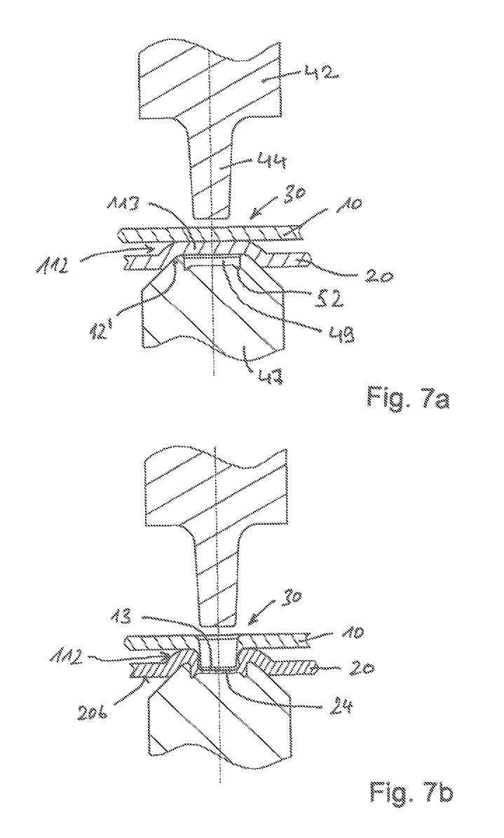

FIG. 7a is a schematically modified embodiment in which the lower plate has been pre-deformed opposite the depression in the die;

FIG. 7b is a schematic cross-sectional drawing of the result of the two connected plates;

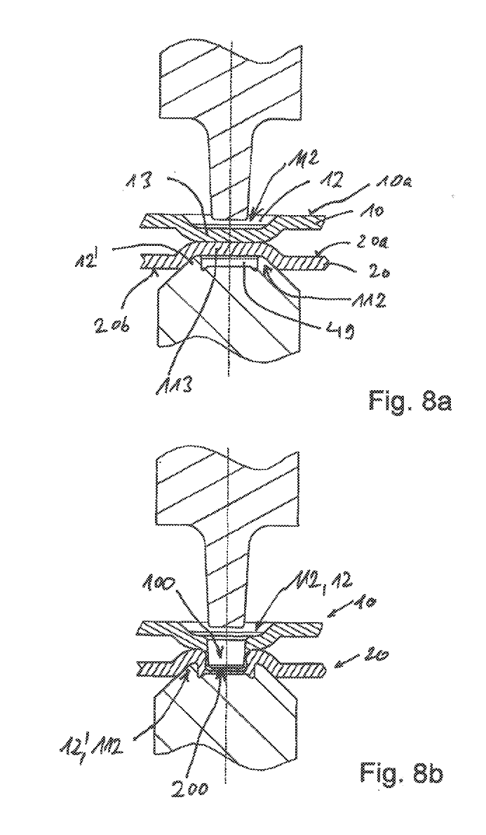

FIG. 8a shows an embodiment modified again from FIG. 7a, in which the two plates have been provided with mutually facing advance depressions;

FIG. 8b shows the result of the two plates connected using the clinching tool of FIG. 8a; and

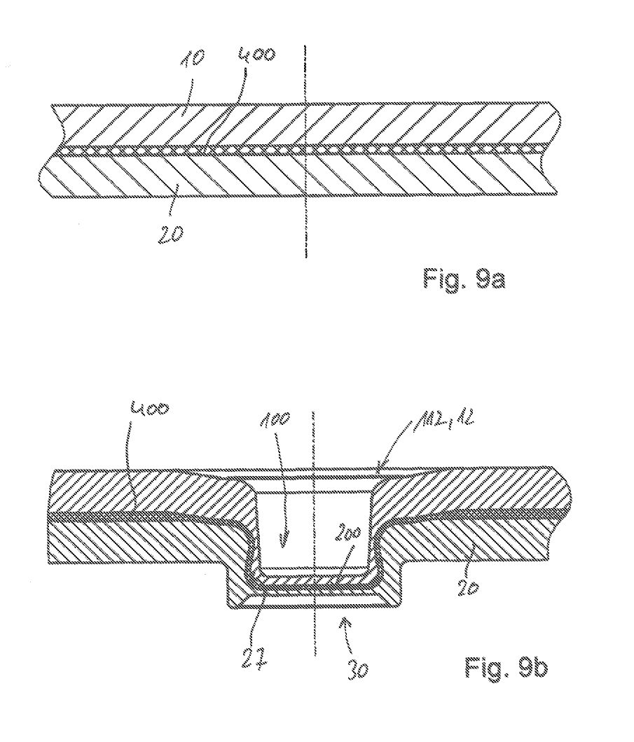

FIG. 9a is a schematic cross-sectional drawing of a starting position of a modified embodiment, in which a capacitive connection is produced between two plates;

FIG. 9b shows the connection accordingly produced within the invention between the first and the second plate, with an insulating film which insulates the two plates interposed;

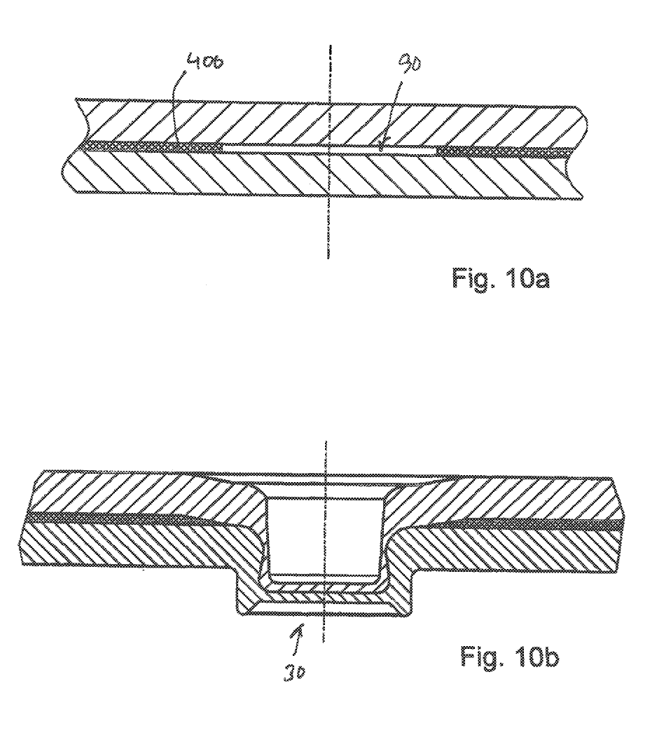

FIG. 10a shows an embodiment modified from FIG. 9a, in which an interposed insulating film comprises a clearance in the connection region; and

FIG. 10b shows the two connected plates produced definitively within the invention with an insulating film interposed comprising the clearance shown in FIG. 10a in the connection region.

FIG. 1 is a schematic detail of a first plate 10 and a second plate 20 which are to be mechanically and electrically interconnected. Since these are electrically conductive plates, generally metal plates or conductor tracks in the form of metal plates, frequent references are made in the following to a first and second metal plate-shaped conductor track or merely a first and second metal plate-shaped conductor track portion or merely conductor track portions for short.

The plates in question, in other words the conductor track portions defined above, are therefore electrically conductive material, for example metal plates consisting of an electrically conductive metal or an alloy, preferably merely comprising one material but possibly also being composed of various materials and/or layers, specifically with or without electrically conductive surface layers and/or portions.

In the embodiment shown, they are two plates 10 and 20 formed in the manner of metal sheets or metal strips, the upper plate 10 extending further to the left and having a right-hand end 11, whilst the lower second plate 20 has a left-hand end 21 and extends further to the right. Connecting a first and a second plate of this type produces a conductive connection which is longer as a whole (but may also be used for example as a dipole with this connection type etc.). The metal sheets or metal strips, metal plates etc. to be connected are thus generally electrically conductive bodies and in particular conductive connections, which may also be used for example as dipoles etc. The selected terminology does not imply any limitations on content.

Reference numeral 10a denotes the upper side and reference numeral 10b denotes the underside of the first plate 10. Reference numeral 20a denotes the upper side of the second plate and reference numeral 20b denotes the underside of the second plate.

In the embodiment shown, the upper plate is of a width B1 smaller than the width B2 of the second plate 20. However, this is not compulsory.

Although in connection with the embodiment reference was primarily made to the two plates 10 and 20, what ultimately matters is merely that two plate portions 10 and 20, in other words conductor track portions 10 and 20, are interconnected by a joining connection within the invention, and subsequently undeformed plate regions 15 or 25 are or may be left behind. Nevertheless, for simplicity reference is made primarily to plates 10 and 20 in the following, even though ultimately two plate portions 10, 20 which can be brought into a more or less parallel position, as explained in detail in the following, are to be interconnected.

To connect the two plates, the upper plate is initially deformed from the plate-shaped initial position thereof according to FIG. 2, specifically by introducing a plate-shaped, pot-shaped or shell-shaped depression 12, although this need not necessarily be rotationally symmetrical. Therefore, a planar base region 13 comprising a base underside 13′, which transitions via laterally rising flanks 14 into the actual remaining undeformed plate region 15, is preferably formed. The depression 12 is thus an advance embossment 112.

This first method step, carried out for example by embossment or deformation using a suitable pressing tool, can be carried out separately so as subsequently to bring the first plate 1 deformed in this manner to lie on the second plate 20 located below, which is still undeformed, in accordance with FIG. 2.

In this situation, clinching, known as pressure joining (toxing), can now be carried out, specifically by means of a suitable clinching tool, explained further in the following, which comprises a punch and a die.

The result of clinching of this type is shown in cross-sectional drawing in FIG. 3.

From this, it can be seen that in the connection region 3 the lower plate 20 comprises a pot-shaped or pot-like depression 200, as is known in principle, which in the embodiment shown is defined by a base region 24 projecting downwards beyond the underside 20b of the second plate 20. Primarily adjacent to the base region 24, the interior 23 of this pot-shaped depression 200 comprises a preferably peripheral undercut 27. As a result, the dimension of this pot-shaped depression 27 parallel to the base plate 24 in at least one direction of extension or in any desired direction of extension is greater than an interior distance 23′ located above (see FIG. 4). As can be seen from FIG. 3 or 4, during the production of the joining connection in the region of the plate-shaped or pot-shaped depression 12, in other words the correspondingly formed advance embossment 112, a further pot-shaped depression 100 is produced in the base region 13 of the advance embossment, and comes to be positioned inside a corresponding pot-shaped depression 200 in the second plate 20. Since, as stated, the peripheral lateral wall or pot wall of the pot-shaped depression 200 of the second plate 20 is provided with an undercut preferably adjacent to the base region 13, material of the first plate is pressed into this undercut 27 here during the press process to produce the joining connection, causing a rigid positive connection to be produced between the first and the second plate.

Thus, the first plate 10, in other words the first conductor track portion 10, forms a first pot-shaped or pot-like depression 100, which engages in a second pot-shaped depression 200 of the second plate 20, in other words in the second conductor track portion 20, and is pressed into this region through the undercut 27 provided there so as to form a positive connection.

By way of the advance embossment 112 initially formed in the first plate 10 and comprising the depression 12, in the two definitively interconnected plates 10, 20, a flank region or shoulder region 14 remains formed, and extends further upwards past the pot-shaped opening rim 26 of the lower, second plate 20, in such a way that the undeformed plate region 15 of the first plate 10 comes to be positioned parallel to the remaining undeformed plate region 25 of the second plate 20 at a distance D. In other words, material regions, primarily the flank or shoulder 14, of the first plate 10 are pressed together with regions of the opening rim 26 of the second plate 20, resulting in the slightly oblique and/or undulating contact and pressing region 33, shown in section in FIG. 3, which extends in the peripheral direction between the two plate materials.

In the embodiment shown, on the underside of the pot-shaped depression 200 the lower plate 20 further comprises a downwardly projecting peripheral rim 28 which result from the use of a specific die shape and has advantages when the two plate materials are pressed together to produce a rigid positive connection. However, this peripheral lower rim 28 need not necessarily be provided, as can also be seen from the modified embodiment shown in FIG. 4.

The following refers to a clinching tool according to FIG. 5, by means of which the connection according to the invention can be produced.

FIG. 5 is a schematic cross-sectional drawing of a detail of a clinching tool 40, specifically having a press punch 41 above, comprising a support shaft 42, on the underside of which in the joining direction 43 the actual working punch 44 projects in axial extension but with a much smaller transverse diameter than the support shaft 42.

The die 47 having a planar upper contact face 48, which is formed as a depression 49 for example in the manner of a blind hole, is arranged in the clinching tool 40 below the plates to be connected.

In the embodiment shown, when a rotationally symmetrical connection is to be produced between the first and the second plate, the deep-drawing depression 49 (sometimes merely referred to as a depression 49 for short) is made pot-shaped or cylindrical. In the embodiment shown, the depression 49 comprises a peripheral annular groove 52, which projects downwards past the surface of the base 50, at the transition from the base 50 to the peripheral defining wall, making it possible to improve the connection further as explained in the following.

In the embodiment shown, the end wall 44′ of the shaping punch 41, leading in the joining direction 43, is planar and thus orientated parallel to the extension direction of the first and second plate 10, 20. The shaping punch 41 is mounted axially rotatable in a corresponding clearance 41a, in other words in a punch housing 41b which receives the shaping punch 41.

In the embodiment shown, the aforementioned punch housing 41b is provided with a clearance 41c underneath, which is defined in the peripheral direction by a peripheral housing portion 41′b projecting in the joining direction 43, and which is dimensioned in the width direction at least in such a way that the first plate 10 is received over a corresponding width. In the longitudinal direction, in other words perpendicular to the plane of the drawing in FIG. 4, the clearance 41c is configured with a length such that the corresponding first plate 10 can optionally be guided out of the clinching tool 40, at least on one side, optionally on two opposite sides, for example if the first plate is to be connected to a second plate in a central region.

Prior to connecting the first and second plate 10, 20, in other words prior to connecting the first and second conductor track portion 10, 20, the first conductor track portion 10 has already been provided with the advance embossment 112 described by way of FIG. 2, comprising the depression 12, in a first embossing step. The height H1 of the clearance 41c corresponds to the height of the first plate 10 pre-deformed in this manner, in such a way that the undeformed material portions, in other words the upper side 15a of the undeformed plate region 15, preferably lie against the downwardly facing retaining face 41d of the punch housing 41b.

The second conductor track portion 20 is positioned in a corresponding clearance 53a in a die housing 53, in which the die 47 is held. It can be seen from the cross-sectional drawing of FIG. 5 that the clearance 53 is of a width greater than the width of the actual die 47. The height H2 of the clearance 53a corresponds to the thickness of the second plate 20.

The arrangement is such that the contact face 29, in other words the upper side 20a of the second plate, and thus the lower defining face 13′ of the base region 13 of the first plate 10, come to be positioned in a plane or a first planar portion E, which corresponds to the separation plane between the punch housing 41b and the die housing 53 in the region of the peripheral punch housing portion 41′b, before the final production of the joining connection. A portion 41′b of the punch housing 41b is positioned on the edge region of the second plate 20 on the upper side 20a thereof.

If the upwardly positioned punch is now moved downwards in the joining direction 43 to carry out the clinching (toxing), a central region of the pot-shaped depression 12 of the first plate 10 and the material region located below of the second plate 20 are pressed into the depression 49 of the die 47 with plastic deformation, similarly to deep-drawing, the corresponding material portions becoming flowable as a result of the high pressures and thus being interconnected with and inside one another positively and non-positively.

Particularly the material portions positioned against one another of the first and second plate 10, 20, which come to be positioned between the end wall 44′, facing downwards in the joining direction, of the shaping punch 41 and the base face 50, in the deep-drawing opening 49 of the die 47, are strongly compressed in such a way that the material of the first and second plate is squeezed radially outwards. During the pressing process, the entire blind hole, in other words the entire depression 49, is filled up between the shaping punch 41 and the depression 49 in the die 47, resulting in simultaneous material-compacting compression of the deformed material. As a result of the squeezing effect, the material of the upper, first plate 10 is radially compressed and expanded sufficiently that a sub-region of the material of the first plate arrives behind a deep-drawing opening 23′ of the lower plate 20, which has an opening size smaller than the radial distance below the deep-drawing opening 23′ adjacent to the base region 24 in the depression 23 of the second plate 20. FIG. 5 shows the situation at the end of the manufacturing process of the joining connection.

In other words, to produce the desired electrical connection (in other words the galvanic connection claimed in the above between two plate-shaped elements 10 and 20, in other words the connection between the two aforementioned metal plate-shaped conductor track portions 10, 20), clinching is described starting from two plate portions 10 and 20, extending mutually parallel, in which planar parts positioned above one another of the conductor track portions 10, 20 are deep-drawn together in the aforementioned deep-drawing opening, and the deep-drawn planar parts are squeezed wide in the deep-drawing direction whilst limiting the expansion in two mutually opposed transverse directions, a deep-drawn and transversely squeezed planar part of the upper plate portion 10 engaging behind the lower plate portion 20 in order for the plate or conductor track portions 10, 20 to hook positively together, in such a way that when the plate material of the first and second plate portions 10, 20 is plastically deformed, a joining connection region 30 occurs in which the two plate portions 10, 20 are positively and non-positively interconnected. This creates an optimum mechanical connection between the two plate portions and in particular an optimum electro-galvanic connection, which has very low intermodulations even in the long term. In other words, within the invention it is possible greatly to reduce the risk of intermodulations occurring, in such a way that in practice intermodulations, or at least significantly intermodulations, barely occur.

To cast the workpiece, the punch 41 is now returned again counter to the joining direction 43, the punch housing 41b now serving as a retaining device which holds the first and second plates in the position thereof shown in FIG. 5, even if withdrawal forces are introduced into the first and second plate during demoulding as a result of the high restoring forces of the punch 41 per se.

The punch housing 41b thus serves as a retaining device, specifically by way of a holding portion 41d against which the undeformed plate region 15 comprising the upper side 15a of the first plate 10 is positioned, in other words cannot be entrained counter to the joining direction when the punch is removed, specifically just like an undeformed edge region of the second plate 20, the surface 20a on which it is positioned against a corresponding contact portion 41′b of the punch housing 41b.

Once the punch 41 has been removed and the punch housing 41b and die housing 53 have been moved apart, the plates which are accordingly rigidly connected by clinching can be removed from the tool. For this purpose, for example, the die 47 may be lifted upwards towards the die housing 53 to some extent, counter to the joining direction 43, so as to lift the two interconnected plates 10, 20 out of the clinching tool 40 as a whole and cast them. The plates which have been rigidly mechanically and electrically connected in this manner can be seen in cross-section in FIGS. 3 and 4.

Since, as stated, a peripheral annular groove 52 is formed in the depression 49 of the die 47 below the base face 50, compression basically results in the cross-sectional shape shown in FIG. 3 having the downwardly projecting edge 28 on the second plate 20. If this annular groove 52 were dispensed with in the depression 49 of the die 47, this would result in a cross-sectional shape as shown in FIG. 4 for the two interconnected plates. Any desired modifications are further possible, depending on the cross-sectional shape of the respective depression in the die.

Since the plates 10, 20 connected in this manner are only mechanically connected, and in particular only electrically connected, at the relevant connection point thereof, in other words the corresponding region 30 connected by clinching, it is ensured that no intermodulations can occur. In addition, the standing wave ratio (VSWR) is also not worsened, since the electrical connection is only produced in the region of the mechanical connection and the two plates 10, 20 are otherwise separated from one another by the distance D in the undeformed plate region thereof.

The schematic cross-sectional drawing of FIG. 6 shows merely in principle that for example the clinching tool 40 may comprise two punches, provided with mutual spacing, and below them two dies, provided with mutual spacing and having corresponding depressions, in such a way that two mutually spaced connection regions 30 may optionally be produced in a combined step, meaning that two plates or metal plate sheets or sheet metal strips etc. can be electrically or mechanically interconnected simultaneously, specifically at a distance D. As a result, two plates or strips are interconnected particularly rigidly, since possible bending loads can act not just at one connection point 30.

FIG. 6a is a schematic perspective drawing, in which a longitudinal section extending through the arrangement shows how two strip-shaped or plate-shaped plates or conductor track portions 10, 20 are rigidly mechanically and electro-galvanically connected in an overlap region at two connection points 30 positioned mutually offset. The arrangement shown is for example arranged at a distance from a conductive metal sheet, for example a metal reflector sheet 71.

Finally, it is also noted that not only plates, in other words in particular metal sheets or sheet-shaped strips, can be mechanically and electrically interconnected in the described manner, but within the invention electrically conductive metal sheets or metal plates for example can also be attached to sheet-shaped housing walls, metal reflector sheets of a mobile communications antenna etc. There are no limitations in this regard.

FIG. 7a shows a modification where instead of the first plate 10 the lower plate 20 is initially provided with an advance embossment 112 having a pot-shaped depression 12′ having a base region 113, in this case in the form of a depression (in this case meaning an elevation) converging towards the first plate 10, the deformation subsequently being carried out in a second step using a correspondingly adapted die.

The connection point 30 is formed in the same way, in other words the two plates or conductor track portions 10 and 20 are rigidly interconnected in the same way, specifically so as to produce an optimum electrical connection. Once the joining connection has been completed (as shown in FIG. 7b), the underside of the base 24 subsequently optionally comes to be positioned at a height which is only slightly different from, in other words positioned slightly lower than, the level of the underside 20b of the second plate, at the same height as the level of the underside 20b of the second plate, or even above this level. This provides the option of the connection point not projecting downwards past the level of the plate 20, in other words past the level of the underside face 20b. The embodiment of FIGS. 7a and 7b differs from the embodiments of FIG. 6 in that the two pot-shaped depressions 100 and 200 which engage in one another, causing the compressed positive connection to be achieved, counter to the plate-shaped, pot-shaped, plate-like or pot-like depression 112 formed in the opposite direction in the second plate 20.

FIGS. 8a and 8b are corresponding views in the case where the first plate 10 having an embossment 112 having a pot-shaped depression 12 is provided with a base region, to project onto the second plate 20, and the second plate is provided with a corresponding advance embossment 112 having a depression 12′ orientated counter thereto is provided with a base region 113, to project onto the first plate 10 (in other words with the opening thereof directed downwards), in such a way that, in the same manner discussed above, when a corresponding punch tool and a corresponding die are used the base in the depression region of the second plate does not project so far past the underside face 20b of the second plate or even ends before it. In all cases, a first pot-shaped depression 100 of the first plate 10 engages in a second pot-shaped depression 200 of the second plate 20, the peripheral wall of the first pot-shaped depression, or at least portions thereof, engaging in corresponding undercuts in the second pot-shaped depression 200 of the second plate 20 so as to achieve the desired positive connection.

This shows that any desired modifications and advance deformations are possible in the region of the connection point 30 so as to provide vertical position adaptation of the connection relative to the level of the respective plate. However, in all cases it is possible within the invention to hold the two plates at a predefined distance D from one another in the undeformed plate region, in other words to ensure here that there is no electrical contacting outside the connection region 30, and this leads to the advantages of the invention being achieved.

FIGS. 9a and 9b show a further modified embodiment.

In the variant of FIG. 9a, a first and a second plate 10, 20 are interconnected by the described clinching method. However, unlike in the previous embodiments, in this case neither the plate 20 nor the plate 20 is provided with an advance embossment 112. The two plates also extend mutually plane-parallel in the connection region 30 to be produced. The arrangement is a sandwich arrangement, in such a way that a third material layer 400 is provided or interposed between the first and second plates. This third material layer 400 preferably consists of an electrically non-conductive layer, in particular a film.

The aforementioned material layer or intermediate layer 400 may consist of a flexible, bendable layer, for example of a film, in particular an insulating film. The thickness of the film is not limited to particular thickness dimensions, so long as this material layer 400 can be deformed together with the plate-shaped portions 10 and 20. Likewise, it is not necessary for this layer 400, in other words this material layer and/or intermediate layer 400, to be formed as a separate layer 400, for example not merely in the form of a film or the like but also in the form of a plate etc. Specifically, it is likewise possible for the plates or plate portions 10, 20 to be connected to be coated with an insulating 400 on the mutually facing sides, in particular at least in the contact region in which the plates are positioned against one another. This may for example be a paint layer, an anodised layer, a dry-application layer or for example a layer applied using rollers. In this case, the layer would thus be a firmly adhering component of at least one plate or both plates, at least on the mutually facing plate faces. There are no limitations in this regard, either in terms of the material or in terms of the material thickness or shaping. Where “film” is generally referred to in the following in reference to this insulating material layer 400, this is intended to mean any possible formation of this layer.

Subsequently, clinching is carried out as described, for example the first plate 10 initially separately undergoing slight advance embossment in the form of a slight plate-shaped depression 112, in two successive steps or else in a first step, if this is in fact necessary or desired, although as stated this is not absolutely compulsory.

Otherwise, again using a suitable punch, a pot-shaped depression 100 is produced in the first plate 10, the pot-shaped peripheral wall of said depression engaging in a corresponding undercut 27 in the second pot-shaped connection 200 of the second plate 20. In the connection region 30, too, the insulating film 400 extends through between the two plates, the production of the clinching connection in this region potentially reducing the film thickness by comparison with the remaining region thereof, as is shown in FIG. 9b.

As a result, a capacitive coupling or connection is produced, in particular as an electrical high-frequency connection. The joining method can be tuned in such a way that the desired size of the capacitive coupling (capacitor) is achieved in particular in the region of the connection 30.

Finally, using a further modified embodiment, FIGS. 10a and 10b show that a galvanic connection 30 can also be produced by the aforementioned clinching method if a film 400 is used as an intermediate layer, similarly to in the embodiment of FIGS. 9a and 9b. However, this film should be provided with a clearance or hole 90, as indicated in the cross-sectional drawing of FIG. 10, in the region of the galvanic connection to be produced. Subsequently, the clinching method is carried out as shown by way of the other embodiments. In this case, an optimum desired galvanic connection is produced between the first and second plate in the connection region 30, since here the film 400 or generally the material layer or intermediate layer 400, separate or firmly connected to a plate, was provided with a clearance 90. Otherwise, this variant starts from two plane-parallel plates 10 and 20, it being possible for at least one plate or both plates (as described for example by way of FIGS. 7a to 8b) initially to be produced with at least a small advance embossment 112 in the form of a slight plate-shaped or pot-shaped depression, in the base region of which the actual pot-shaped depression of the first plate 10 subsequently occurs, which engages in the corresponding undercut 27 of the pot-shaped depression 200 of the second plate 20 in the connection region 30.

1. Method for producing an electrical high-frequency connection between at least two plate-shaped metal conductor track portions, for producing a galvanic or capacitive electrical connection, comprising:
the at least two conductor track portions to be electrically connected are arranged at a distance from one another in a parallel position, at least in a plate region of the conductor track portions which remains undeformed during the production process, and
in a connection region, the at least two conductor track portions are interconnected using a clinching tool so as to produce a clinching connection.

2. Method according to claim 1, wherein an advance embossment having a depression is formed in at least one of the at least two conductor track portions in the connection region, in such a way that a base region which is thus formed comes to be positioned offset from the undeformed plate region of the conductor track portions, and in that the at least two conductor track portions are positioned with respect to one another in such a way that the base region of the at least one conductor track portion provided with the advance embossment is brought into contact with the second conductor track portion directly or with an insulating material layer or intermediate layer interposed, and in that the clinching connection is produced in this region.

3. Method according to claim 1, wherein an insulating material layer or intermediate layer is provided sandwiched between the two conductor track portions to be connected, and is provided with a clearance in the region of the clinching connection to be produced before it is produced, through which clearance the pot-shaped depression of the first conductor track portion engages in the pot-shaped depression of the second conductor track portion to produce a galvanic contact between the two conductor track portions after the clinching connection has been produced.

4. Method according to claim 1, wherein an insulating material layer or intermediate layer is arranged between the two conductor track portions to be connected, or in that an insulating material layer or intermediate layer is provided or formed at least in the connection region on at least one side of a conductor track portion positioned facing the respective other conductor track portion to be connected thereto, in such a way that the insulating material layer or intermediate layer is also provided in the connection region between the pot-shaped depressions, which engage in one another, of the first and second conductor track portion so as to form a capacitive connection between the two conductor track portions.

5. Method according to claim 2, wherein, by forming an advance embossment so as to form a depression in at least one or the two conductor track portions or in both conductor track portions in the region of the depression a peripheral flare or peripheral flank is formed, the advance embossment formed on at least one conductor track portion being positioned against the other conductor track portion or against the further advance embossment formed on the other conductor track portion, directly or with the insulating material layer or intermediate layer interposed, in the connection region, and in that the at least two undeformed plate regions of the two conductor track portions are already held at a distance from one another before the clinching connection is produced.

6. Method according to claim 1, wherein an insulated material layer or intermediate layer is used which consists of or comprises
a separate material layer or intermediate layer, in particular in the form of a deformable plate, or
a film, or
a layer formed on or adhering to at least one of the two conductor track potions to be connected, in particular in the form of a lacquer layer, an anodised layer, a rolled-on layer or a glued-on layer or a similar layer.

7. Method according to claim 2, wherein the clinching connection is produced in such a way that the closed base region projects beyond the upper side or underside of the associated conductor track positioned facing away from the respective other conductor track portion.

8. Method according to claim 1, wherein the clinching connection is produced in such a way that the closed base is positioned at the height of the upper side or underside of the associated conductor track portion or projects beyond the upper side of the associated conductor track potion.

9. Method according to claim 1, wherein an advance embossment is formed in at least one of the two conductor track portions in a first step before producing the clinching connection or simultaneously with this,

10. Method according to claim 1, wherein at least two or more clinching connections are simultaneously produced between at least two conductor track portions to be connected, preferable using a shared clinching tool.

11. Electrical high-frequency connection, comprising:
at least two plate-shaped metal conductor track portions,
the at least two conductor track portions being held or arranged at a distance from one another adjacent to the clinching connection,
at least one of the two conductor track portions comprises, adjacent to the clinching connection, a peripheral flare or peripheral flank, which extends away from the at least one adjacent conductor track portion, and/or an insulating material layer or intermediate layer is provided between the at least two conductor track portions at least adjacent to the clinching connection or the undeformed plate region of the conductor track portions, and
the at least two conductor track portions interconnected by the clinching connection are held at a distance from one another in the undeformed plate region thereof.

12. Electrical high-frequency connection according to claim 11, wherein the at least two connected conductor track portions each comprise, adjacent to the clinching connection thereof, a peripheral flare or peripheral flank, these being directed away from one another, causing the at least two undeformed plate regions of the two conductor track portions to be held at a distance from one another.

13. Electrical high-frequency connection according to claim 11, wherein the insulating material layer or intermediate layer, provided at least in the undeformed plate region between the two conductor track portions, is provided with a clearance in the clinching connection, through which the two conductor track portions are galvanically contacted via the clinching connection.

14. Electrical high-frequency connection according to claim 13, the material layer or intermediate layer consists of a separate material layer or intermediate layer inserted between the conductor track portions, in particular in the form of a plate or a film, or in that the material layer or intermediate layer is firmly connected to one of the two conductor track portions on at least one side.

15. Electrical high-frequency connection according to claim 11, wherein an insulating material layer or intermediate layer, extending past the cinching connection, is provided between the two conductor track portions, via which layer a capacitive connection is formed between the first and second conductor track portion in the connection region.

16. Electrical high-frequency connection according to claim 11, wherein that a closed base is formed in the at least one conductor track portion in the region of the clinching connection, and is positioned beyond the upper side or underside of the associated conductor track portion or at the level of the upper side or underside of the associated conductor track portion.

17. Electrical high-frequency connection according to claim 16, wherein the clinching connection is produced in such a way that the closed base projects beyond the underside or the upper side of the associated conductor track portion.

18. Electrical high-frequency connection according to claim 11, wherein at least two or more clinching connections are formed between at least two conductor track potions with a mutual lateral offset.

19. Electrical high-frequency connection between at least two conductor track portions, produced by a method according to claim 1.

20. Method comprising:
arranging first and second plate-shaped metal conductor track portions at a distance from one another in a parallel position, the track portions each having a plate-shaped region; and
using a clinching tool to produce a clinching connection that interconnects the first and second plate-shaped metal conductor track portions without deforming the conductor track portions at least in the plate regions of the conductor track portions to thereby produce an electrical high-frequency galvanic or capacitive connection between the first and second plate-shaped metal conductor track portions.
